(19) United States
(12) Patent Application Publication
(10) Pub. No.: US 2004/0094919 A1
(43) Pub. Date: May 20, 2004

(54) Baggage item with rollers

(76) Inventors: Klaus Roder, Munchen (DE); Martin Roder, Ravensburg (DE)

Correspondence Address: Leopold Presser, Scully Scott Murphy & Presser, 400 Garden City Plaza, Garden City, NY, 11530, US

(21) Appl. No.: 10/240,359

(22) PCT Filed: Mar. 28, 2001
(86) PCT No.: PCT/DE01/01199

(30) Foreign Application Priority Data
Mar. 28, 2000 (DE) 100 15 422.0

(51) Int. Cl. B62B 3/02

(52) U.S. Cl. 280/30; 280/655; 280/87.01

(57) ABSTRACT

Baggage item with at least two rollers, whereby at least one of the rollers can be moved into an operative position that is at a distance from the projected area of the baggage item if seen in top view, in order to improve the standing and/or rolling characteristics of the baggage item, whereby a standing surface is provided by an associated flat element, whereby the standing surface makes it possible to safely travel with the baggage item in a scooter-like manner.

### Field of the Invention

The present invention concerns baggage items with rollers, and in particular a baggage item with at least two rollers, whereby the term baggage item in general is to be understood to mean a suitcase, a bag, or similar device, or a so-called shopper, i.e. a shopping bag equipped with rollers or wheels.

### BACKGROUND OF THE INVENTION

There exist a large number of known baggage items with at least two rollers, such as for example hard-top suitcases, which are equipped on one edge with an axle with two rollers, whereby the diagonally opposite edge usually is provided with a handle to be able to pull the suitcase. Also known in this field are so-called trolleys, which are usually smaller-size suitcases, in which the axle with two rollers extends in parallel to one of the main surfaces of the suitcase. In this type of luggage, the mentioned surface is usually provided with an extractable handle device, so that it becomes possible to pull the trolley behind in an inclined position.

Recent years have seen the introduction of suitcases that contain an electric motor and can be driven in a vehicle-like manner, but these suitcases only possess very limited storage capacity. DE-A-3636064 discloses a suitcase that can be used as a means of locomotion. This suitcase is equipped with wheels, which project 2p from its lower narrow side, and consequently may be used as a scooter, since the rotational axis of at least one wheel can be swivelled in a plane that is parallel to the lower narrow side, whereby an element to stand on is provided in the lower area of the suitcase and may be moved outward, and whereby the suitcase further is provided with a grip element above the swivelling wheel. This suitcase is not particularly comfortable to operate, since the user has to stand on the side of the suitcase and has to lean over the suitcase. This also has a negative effect on the manoeuvrability that there is a substantial risk of the suitcase tipping over when it is used as a scooter, whereby the stability is only comparable to conventional suitcases if the step en is not used.

Several proposals have been made in the past to attach additional small baggage items to an existing larger-size baggage item, whereby belt- or strap-like means are used for this purpose. As an alternative, DE-A-3512844 describes a roller treatment of childhood ALL. Determbination of the tissue expression levels of the RFC might have 4 relevance farrane ontifolate therapy. On the basis of transport kinetic studies, RFC expression was demonstrated in some normal mammalian cells (e.g., mouse small 5 intestine, rat hepatocytes and rabbit kidney) and in var ious rodent and human derived tum or cell s including leukemi a, . sarcomas, hepatomas and carcinomas of breast, lung and ovary. Matherly et al. were able to determine the human tissue distribution of RFC by immunohistochemistry. These studies also showed that RFC was present 1o in many c ells and tissues, both normal and neoplastic. High RFC expression was detected in prostate, testis, liver, and adrenal sections. In tissue sections from primary human tumors, the RFC w as detected in m elanoma, wymphoma, and astrocy toma sections and in prostatic, pancreatic, gastric, thyroid, breast, ovarian, colon, renal, hepatocellular, 15 and lung carcinomas.

As has already been said above, although the involvement of RoFC i n re duced folate and antifolate compounds uptake is well studied and further, although mutations in rodent RFC gene and a single mutation in human RFC gene wh ich alter such up take were detected in rodent and 20 human cell lines, no evidence has been so far provided to the effect that a similar mechanism of altered uptake characterizes tumor cells in vivo. Wh ile reducing the present invention to practice, as is further detailed and exemplified in the following sections, it nas found that at least in some cases RFC mutations are responsible for such altered uptake ill 25 v ivo. These findinds have bagg e itense th erapeutic implica tions in selection of appropriate chemotherapy and monitoring the cancer patien t through and between chemotherapy sessions. we4abamalean cells cannot synthesize iolates and therefore must relic on their oopn uptake from exogenous sources (1). As detailed above, the the baggage item if seen in a top view. This results in improved standing and rolling characteristics of the baggage item. Due to the resulting stable arrangement when standing or rolling, a user on the standing surface can in an especially comfortable and safe manner use the baggage item as a means of locomotion in a scooter-like manner.

Preferably, the flat element is connected to the baggage item in a sliding manner, in particular in a sliding and swivelling manner. Executing the flat element so that it can slide with respect to the baggage item makes it possible to simply slide it out if required, whereby one can also envision a telescoping arrangement in order to optimize the useable length of the standing surface and the operating characteristics in scooter mode. A sliding and swivelling linkage to the baggage item allows a versatile and space-saving positioning with respect to the baggage item in the stand-by position.

For the purpose of improving the usage characteristics as a scooter of the baggage item according to the invention, it may be practical to connect the flat element with the baggage item in a way allowing biaxial rotation. This may for example involve a first axis that is oriented essentially parallel to the roller axles, as well as a second axis that is at a right angle with respect to the first one.

In a preferred embodiment, the flat element or the roller that may be moved to a set-apart position can be locked with respect to a direction of movement that is used for switching between the stand-by position and the operating position, while a rotation along a plane that contains the rollers is optionally possible.

For example, if the flat element is linked to the baggage item in a biaxial manner, then it could be rotated about an essentially horizontal axis to move it to the operating position and to lock it there. Once this configuration has been reached, a rotation about an essentially vertical axis may take place to create a scooter-like baggage item, which could be steered by allowing a rotation of the baggage item with respect to the flat standing element.

Preferably the pivot point of the flat element or the roller, which can be moved to a distanced position, to change from the stand-by position to the operating position is located at a distance from the other roller(s), in particular at a distance of essentially one baggage item dimension minus the radius of one of the other rollers. The distance between the roller axle and the swivelling axis makes it possible to place the centre of gravity of the baggage item—irrespective of whether it is in the operating position or in the stand-by position—in an area that is located close to the ground between the rollers. A further advantage may be realized if during the switch from the stand-by position to the operating position the baggage item itself can be elevated and moved higher, which would ensure improved ease of use, especially for tall users.

It is also preferable if the baggage item is equipped with a handle that serves as a steering means. In the design of the steering function one can use various known means such as Bowden wires, steering linkage, hydraulic equipment, an electric motor, gear wheels, pneumatic equipment, etc. Providing steering means can significantly improve the manoeuvrability of the baggage item, in particular if the baggage item is being pushed, pulled, or if it is used like a scooter or skateboard.

Finally, it is preferable if at least one of the rollers is steerable, in particular steerable by the application of a force. Including at least one steerable roller, which can be a roller that can be moved to a set-apart position or another roller, makes it possible to implement very different steering characteristics in accordance with the wishes of the user.

As an example one can mention an elastically supported axle, whereby an application of force leads to a steering movement of the rollers attached to said axle. This axle could for example be provided on an edge of the baggage item, while a different edge could be equipped with the roller that can be moved to a set-apart position, e.g. attached to a flat element, so that the baggage item can be steered in a manner similar to that of a skateboard.

### BRIEF DESCRIPTION OF THE DRAWINGS

Further advantages and features of the invention are the subject of the following description of presently preferred embodiments, which refers to the enclosed drawings.

FIG. 1 shows a lateral view of a suitcase as a first preferred embodiment.

FIG. 2 shows a view from below the suitcase of FIG. 1.

FIG. 3 shows the suitcase shown in FIGS. 1 and 2 in a view similar to that of FIG. 2, but with the roller that can be moved to a set-apart position in its standby position.

FIG. 4 shows a lateral view of a further suitcase as the second preferred embodiment of the invention.

FIG. 5 shows the suitcase of FIG. 4, whereby the roller that can be moved to a set-apart position is located in its position close to the baggage item.

FIG. 6 shows a view from below a baggage item as a further preferred embodiment.

FIG. 7 shows a view from below a further preferred embodiment of a baggage item according to the invention.

FIG. 8 shows a lateral view of yet another embodiment of the baggage item according to the invention, whereby the baggage item can be wheeled in a direction that is essentially at right angles to the main surface.

FIG. 9 shows a view from below the embodiment shown in FIG. 8.

FIG. 10 shows the embodiment of FIGS. 8 and 9 in a view similar to that of FIG. 9, whereby the roller that can be moved to a set-apart position is in its stand-by position;

FIG. 11 a lateral view of yet another preferred embodiment of the baggage item according to the invention.

FIG. 12 again shows a lateral view of the embodiment shown in FIG. 11, whereby the handle is retracted and the roller that can be moved to a set-apart position is in its position close to the baggage item.

FIGS. 13 to 16 show a further preferred embodiment in various positions.

Finally, FIGS. 17 and 18 show a further development of the embodiment illustrated in FIGS. 13 to 16.

### DETAILED DESCRIPTION OF A PREFERRED EMBODIMENT

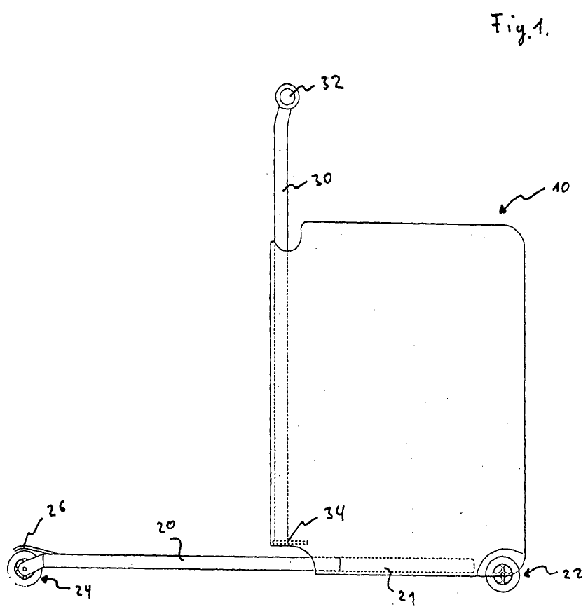

FIG. 1 shows a lateral view of a suitcase 10 as a preferred embodiment of a baggage item according to the invention. The suitcase 10 is equipped with a roller 22 at a corner of its main surface. Along the edge adjacent to that corner, the illustrated embodiment is equipped with a pull-out mechanism 20, 21, at the distant end of which is attached a roller 24. In the shown embodiment, the distant end also is equipped with a braking mechanism 26, which can affect the roller 24 if acted on from above. The suitcase 10 further comprises a handle 32, which is connected to the baggage item itself by means of a telescopic rod 30. In the illustrated embodiment, at the lower end 34 of the rod 30 is provided a Bowden wire (not shown), which can exert a steering action on the axle that supports the roller 22.

Thus, turning the handle 32 about the rod 30 changes the direction of the roller 22, so that the entire baggage item can be moved in a scooter-like manner, whereby the reference label 20 indicates a standing surface that is provided for the user but can also be used to store additional baggage items.

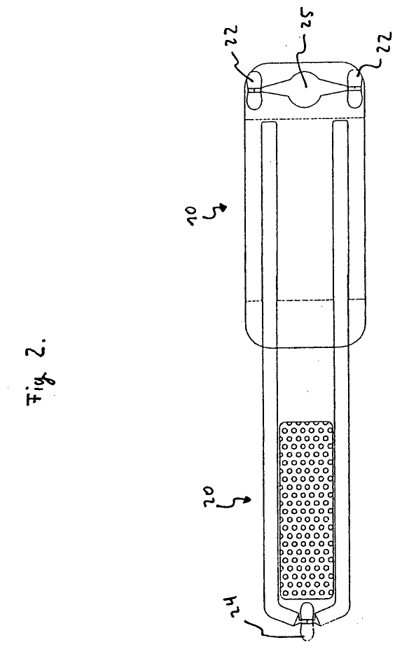

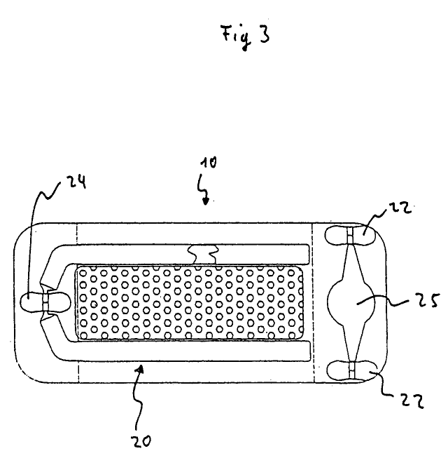

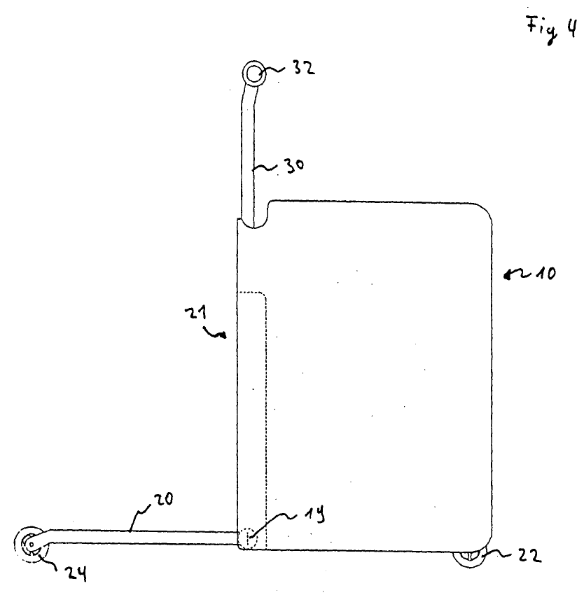

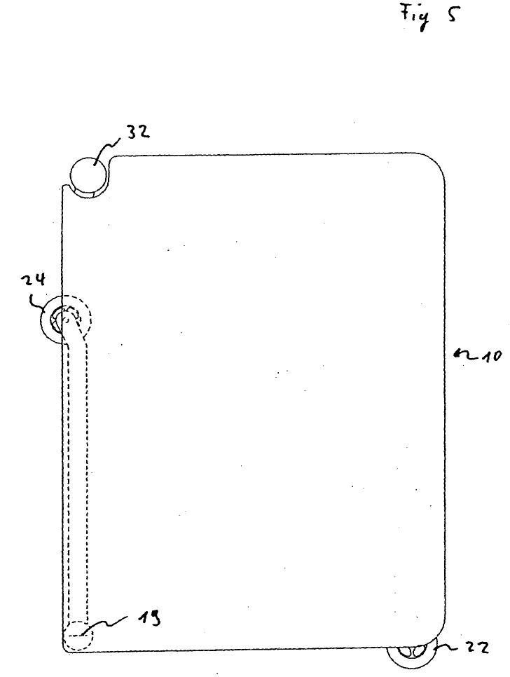

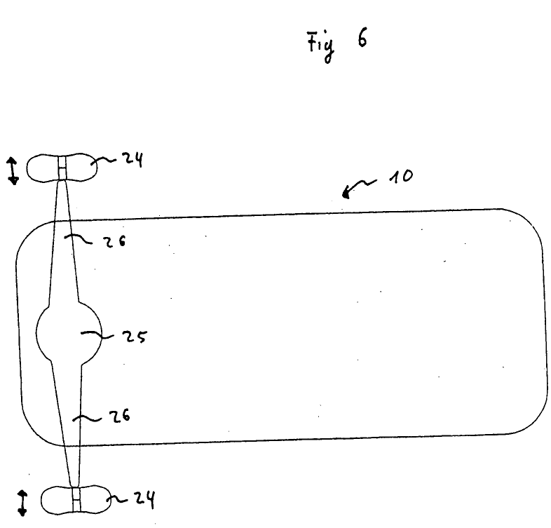

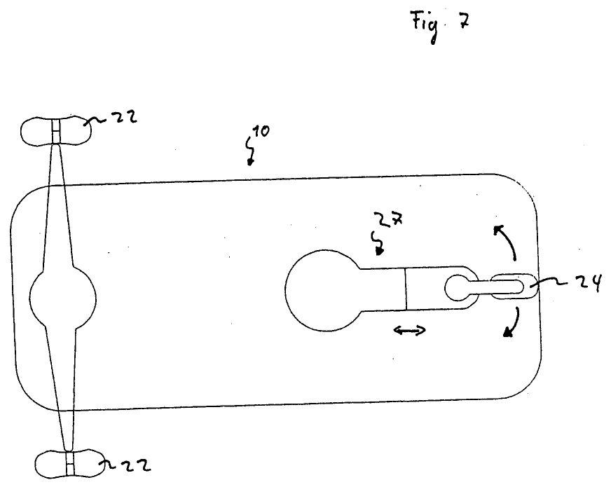

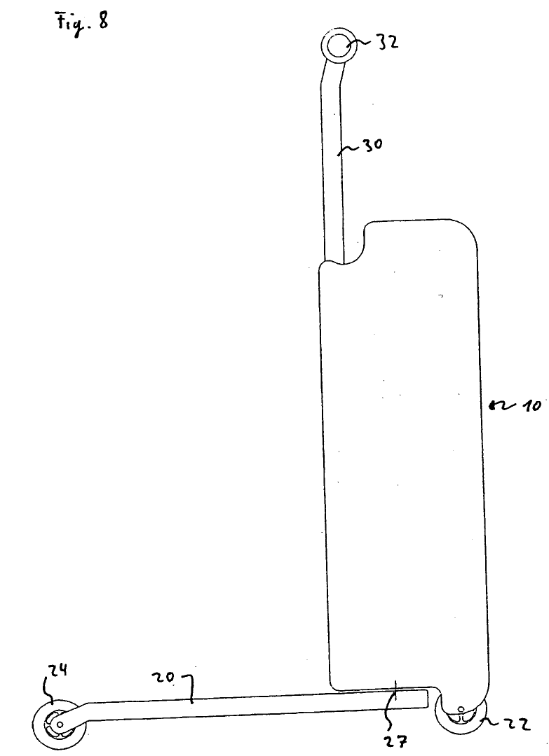

As can clearly be seen in FIG. 2, which is a view from below the suitcase of FIG. 1, this embodiment of the baggage item is equipped with two rollers 22 that are supported on one axle 25 and one roller 24 that is arranged on the flat element 20, whereby this roller—as illustrated—can be positioned in a position that is at some distance from the projected area of the baggage area. A person skilled in the art will gather from this view that instead of the above-mentioned Bowden-wire steering mechanism an elastic axle 25 could be used to implement steering, so that inclining the baggage item would result in a corresponding change in direction.

Once the user has delivered the baggage item to the location where the baggage item is usually checked in or stored, the user can simply push the flat element 20 under the suitcase, resulting in the configuration shown in FIG. 3. In this configuration the dimensions of the baggage item are the same as those that are usually standard for baggage items, with no projecting components. It should be noted that even though they are not illustrated, locking or holding devices may be provided in both of the positions that are illustrated in FIGS. 2 and 3 to prevent a transition from one to the other position. position. In proximity to the reference label 27, the flat element 20 is hinged to the suitcase in such a manner that it can be rotated in an essentially horizontal plane.

Positioning the pivot point in proximity to the reference label 27 allows a significant improvement of the steering characteristics of th e baggage item and eliminates the need for complicated mechanisms for the steering of one or several rollers. Thus, in the illustrated embodiment, action on the handle 32 of the pull-out handlebar 30 changes the direction of the baggage item 10, whereby—even though this is not illustrated—this embodiment may be provided with a braking device, which may act either o n the roller 22 or on the roller 24, possibly by mean s of a Bowden wire.

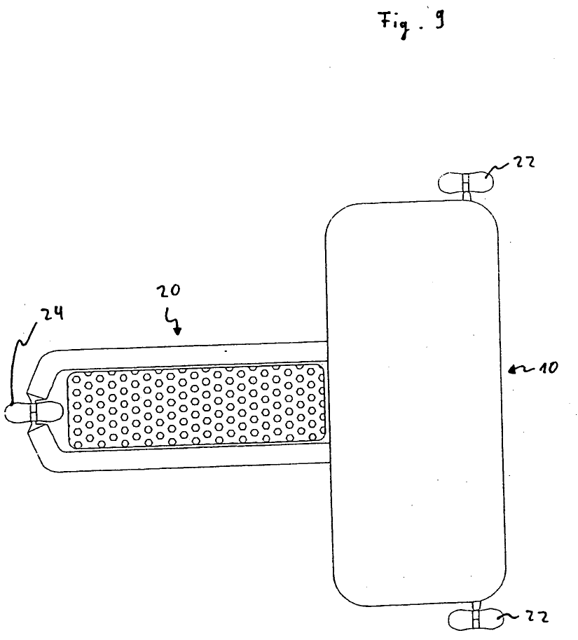

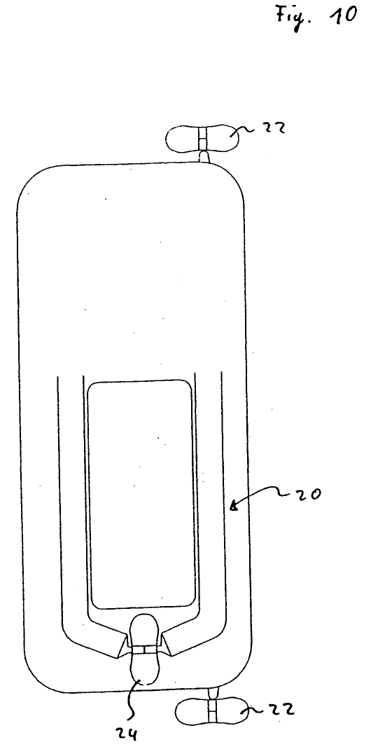

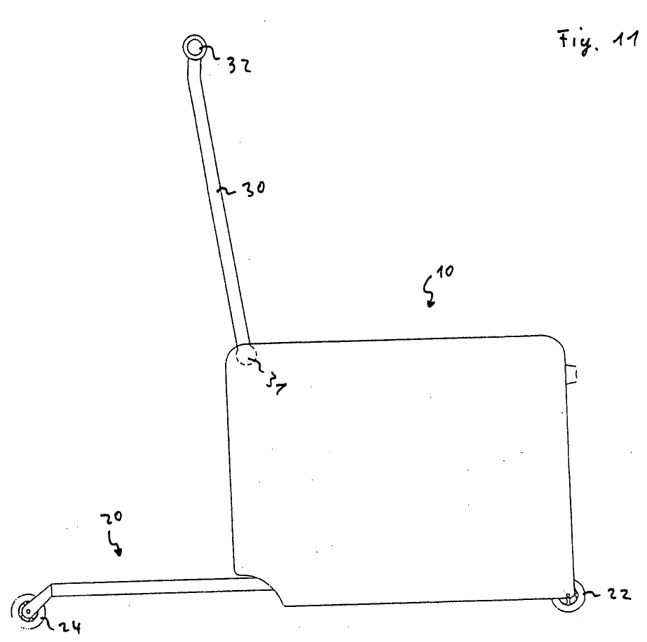

FIG. 10 shows the embodiment illustrated in FIGS. 8 and 9 with the flat element and the associated roller 24 in their stand-by position, i.e. underneath the suitcase. In this embodiment it could be made possible in an advantageous manner that swivelling the flat element 20 into this position slightly lifts the roller 24. In order to be able to provide as large a standing surface or storage area by means of the flat element 20 as possible, this element 20 is attached to the baggage item 10 in a sliding and swivelling manner, so that for storage purposes the flat element is at first swivelled and subsequently is pushed under the suitcase or is collapsed in a telescope-like manner.

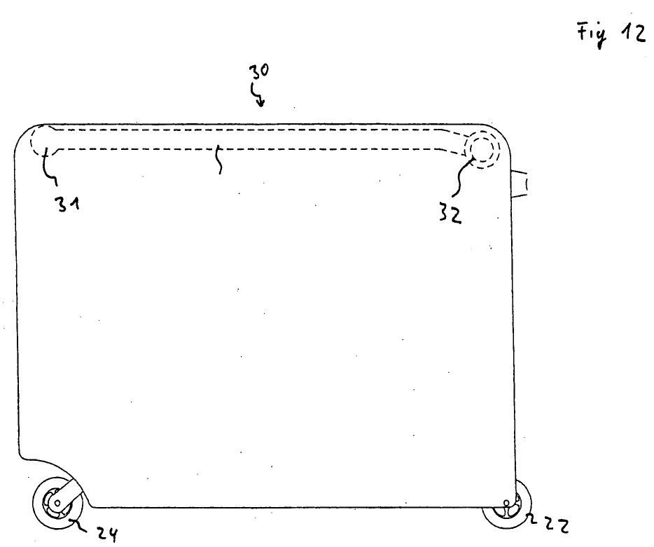

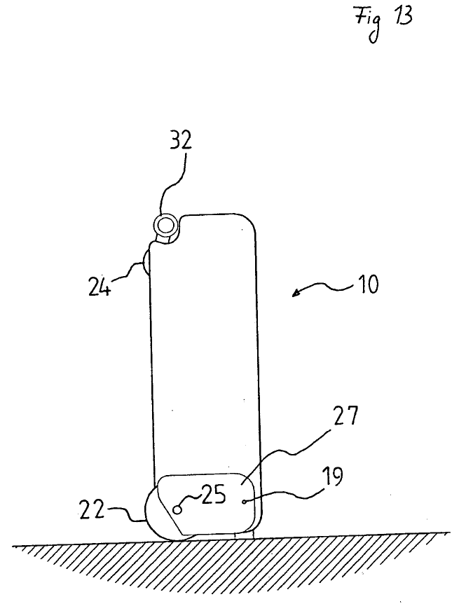

FIGS. 11 and 12 show a further variant of a baggage item according to the invention. In this baggage item, the steering rod 30 with the associated handle 32 is attached to the baggage item 10 free to swivel by means of a hinge 31. The embodiment shown here also is provided with a flat element 20 with a roller 24 attached thereto, whereby this embodiment offers the additional advantage that the baggage item may also be rolled via the rollers 22, while the flat element 20 with the associated roller 24 may be used as a handle.

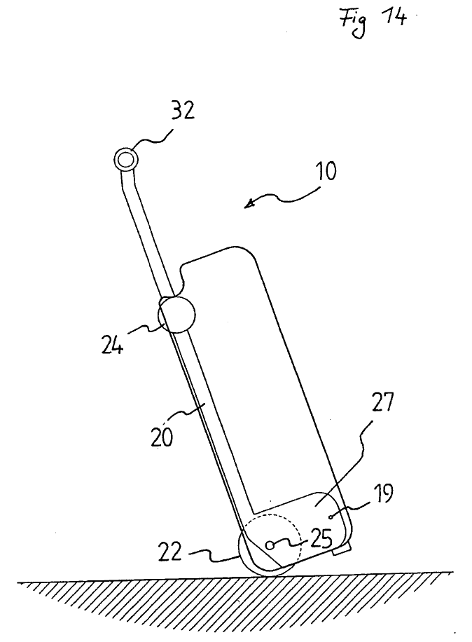

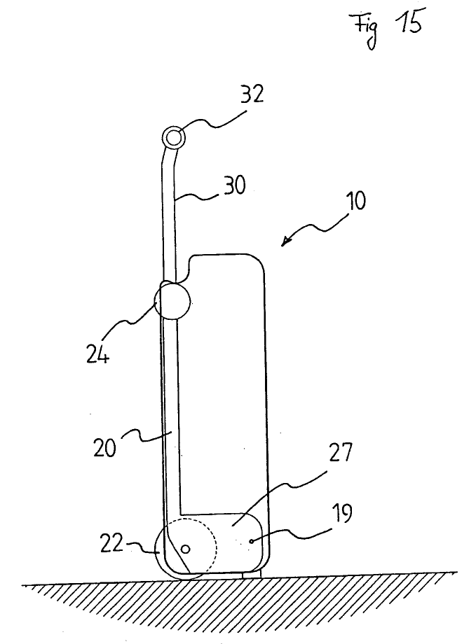

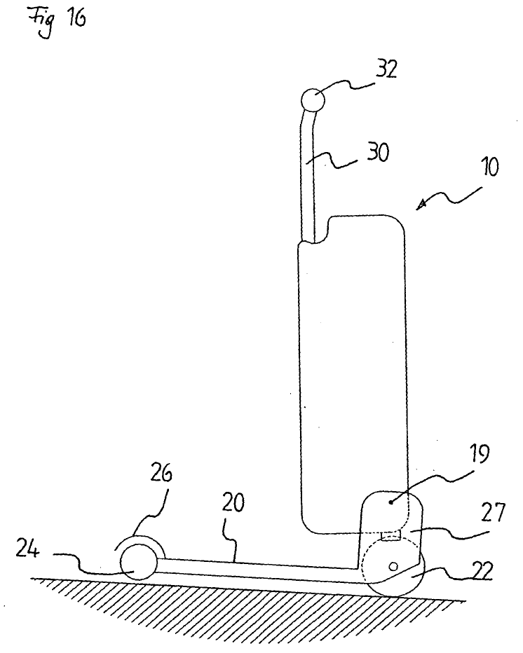

FIGS. 13 to 16 show a preferred embodiment in various possible positions. The illustrated baggage item 10 has a trolley-like design and comprises a handle 32, which may be retracted (FIG. 13) and extended (FIG. 14). In addition, the baggage item in the shown embodiment is equipped with two rollers that are arranged in the lateral area of the short lateral edge of the baggage item, whereby these rollers have a relatively large diameter, which improves the rolling characteristics.

In the illustrated embodiment, the rollers have a diameter of approximately 20 cm. In contrast to the above-described embodiments, the rollers 22 are not attached immediately to the baggage item 10 itself, but to an intermediate element 27, which contains the axle or axles 25 of the roller or rollers 22. This element 27 is coupled to the baggage item 10 at the position of the reference label 19.

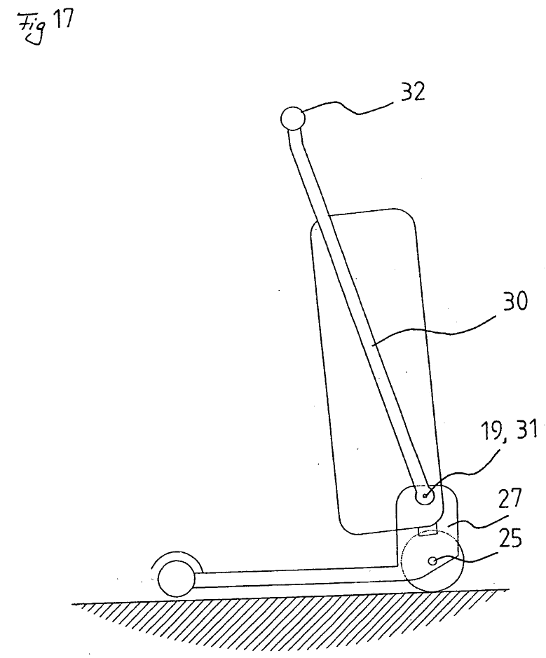

Starting from the configuration that is illustrated in FIG. 13, a user will at first pull out the handle 32 to be able to subsequently pull the suitcase like a trolley, as is shown in FIG. 14. In this configuration, the flat standing element 20, which together with its associated roller 24 is connected with the element 27, is in its standby position. If the user wishes to put down the baggage item, then he can easily do so in a manner that is usually used with trolleys and is shown in FIG. 15.

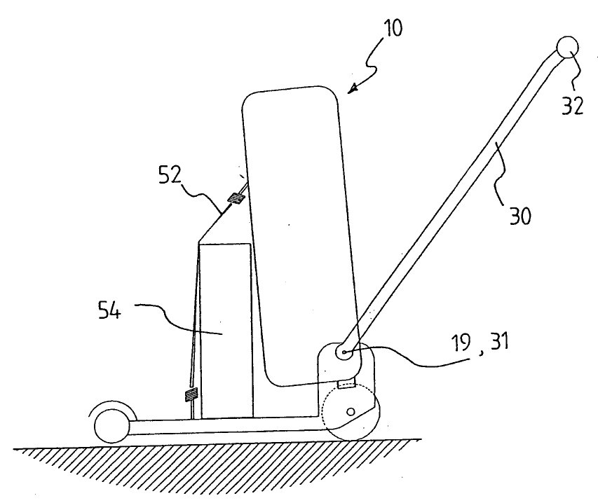

Starting from this position, the shown embodiment of the baggage item according to the invention can easily be converted to a scooter-like vehicle by swivelling the flat element 20 about the pivot point 19. The element 27, which provides a distance between the pivot point 19 and the axle 25, carries the roller 22 below the centre of gravity, so that the configuration shown in FIG. 16 represents a stable arrangement. Naturally, appropriate locking means are provided to secure this configuration, but these means are not illustrated and shall not be discussed in any detail. The important fact is that the invention aids in achieving significantly improved standing stability and rolling characteristics, which contribute to a comfortable and safe scooter-like operation.

FIGS. 17 and 18 shows a further development of the above-described embodiment. In this embodiment, the pivot point at the point 19 is combined with the pivot point of the rod 30 of the handle 32. As can easily be seen, this adds the functional scope of a pullable cart with a drawbar to the functionality of the above-described embodiment.

Even though the description of the embodiments of FIGS. 13 to 18 illustrates and describes the flat element 20 as being rigidly connected with respect to the element 27, it is within the scope of the invention'to provide—instead of this rigid connection—a hinged connection that allows the flat element 20 to be swivelled with respect to the baggage item in a horizontal plane, which further improves the steering characteristics.

The driving and steering characteristics can be improved further by including a so-called caster angle. This can for example include an inclination of the steering rod with respect to a steerable roller or the placement of a steerable roller or rollers in front of the swivelling steering means.

Even though the invention has been described completely and in detail with reference to presently preferred embodiments, a person skilled in the art will recognize that various changes and modifications are within the scope of the claims without deviating from the invention's idea. It should be particularly noted that any individual feature of one embodiment can be combined with any of the other features of the other embodiments. Finally it should be mentioned that various arrangements and numbers of braked and un-braked, steerable and un-steerable rollers are possible, such as for example one stationary roller and two rollers that can be moved to a set-apart position, whereby various steering and braking means can be employed.

What is claimed is:

1. Baggage item (10) with at least two rollers (22, 24), whereby at least one of the rollers (22, 24) can be moved to an operating position in which it can be locked and which is at a distance from the projected area of the baggage item (10) if seen in a top view, characterized in that the roller that can be moved to a set-apart position acts in the operating position as roller that supports the baggage item, which is attached to the baggage item (10) via the flat element (20) that can be used as standing surface.

2. Baggage item (10) according to claim 1, characterized in that the flat element (20) is connected to the baggage item (10) in a manner allowing it to slide, in particular allowing it to slide and swivel.

3. Baggage item (10) according to claim 1 or 2, characterized in that the flat element (20) is connected with the baggage item (10) in a way allowing biaxial rotation.

4. Baggage item (10) according to one of the preceding claims, characterized in that the flat element (20)/the roller (24) that can be moved to a set-apart position can be locked with respect to a direction of movement that is used to switch between the stand-by position and the operating position, while a rotation in a plane that contains the rollers (22, 24) is optionally possible.

5. Baggage item (10) according to one of the preceding claims, characterized in that a pivot point (19)—for switching between the stand-by position and the operating position—of the flat element (20)/the roller (24) that can be moved to a set-apart position is located at a distance from the other roller(s), in particular at a distance of essentially one baggage item dimension minus the radius of one of the other rollers (22).

6. Baggage item (10) according to one of the preceding claims, characterized in that the baggage item (10) is equipped with a handle (30, 32) that serves as steering means.

7. Baggage item according to claim 6, characterized in that the steering means act on an axle (25), in particular that for this purpose they are flange-mounted like a drawbar.

8. Baggage item according to claim 7, characterized in that the rollers that are provided on one axle (25) are braked as a result of certain rotational or swivel positions of the steering means.

9. Baggage item (10) according to one of the preceding claims, characterized in that at least one of the rollers (22, 24) is steerable, in particular steerable by the application of force.

10. Baggage item (10) according to one of the preceding claims, characterized in that at least one of the rollers (22, 24) is equipped with a braking device (26).
